(19) United States
(12) Patent Application Publication
(10) Pub. No.: US 2008/0136649 A1
(43) Pub. Date: Jun. 12, 2008

(54) ACCESS CONTROL SYSTEM AND SANITIZING STATION

(76) Inventor: Joseph F. Van De Hey, Kaukauna, WI (US)

Correspondence Address: GODFREY & KAHN S.C., 780 NORTH WATER STREET, MILWAUKEE, WI, 53202, US

(21) Appl. No.: 11/870,298

(22) Filed: Oct. 10, 2007

Related U.S. Application Data
(60) Provisional application No. 60/869,662, filed on Dec. 12, 2006.

(51) Int. Cl. G08B 23/00

(52) U.S. Cl. 340/573.1; 221/7; 340/5.2

(57) ABSTRACT

A system for controlling access and recording who has been allowed or denied access to controlled access areas. A sanitization station which controls access to protected areas and records who has been allowed to enter and who has been denied entry to the area. Improved sanitization stations providing greater safety and efficacy as well as efficient and clean operation. Access control systems and stations that record attempts to access protected areas through the station, permit or deny access to the protected based on preset rules or permissions, and also record compliance with requirements for access to the protected area by authorized persons. The systems and stations may trigger local or remote alarms when an unauthorized person enters or attempts to enter a protected area, or fails to comply with conditions required to gain admission to the protected area.

### CROSS-REFERENCE TO RELATED APPLICATIONS

The present application claims benefit of earlier filed provisional application U.S. Ser. No. 60/869,662, filed on Dec. 12, 2006, the disclosure of which is incorporated herein by reference.

### BACKGROUND

In a number of industries, it is vital to ensure that employees and other persons coming into contact with goods or animals during production are adequately sanitized to prevent contamination or infection. Examples of such industries include but are not limited to perishable food processing, baby food or formula production, poultry, lamb, swine and other domesticated animal breeding, production and processing, pharmaceuticals production, as well as many others.

In these industries, it is common to require employees and anyone entering the area of product preparation and handling to pass through a sanitization process. However, it is also common for such sanitization requirements to be bypassed. If a subsequent contamination occurs in the product, the ability to trace back to a source of the contamination may be tremendously valuable both in terms of liability and in terms of improving the sanitization process to avoid future contamination.

In addition to sanitizing hands and/or feet of persons entering the area, it may also be desirable to screen any person entering production and handling areas for disease or infection, such as might be indicated by an elevated temperature, or sudden changes in body weight. Persons experiencing elevated temperatures or sudden changes in body weight may be prohibited from entering an area without first being checked for the cause of these biometric changes.

In these and other industries, it may be desirable to track who has had access to different portions of the production process and what sort of training or screening they may have had. For example, in facilities where a worker or visitor may be exposed to emergency response situations which require the ability to distinguish a green or red flashing warning light, any persons entering that space should have been screened for green/red colorblindness. In another example, in some environments, it may be a requirement that all persons entering an area have received a safety briefing. It may also be desirable that records be kept of who has been permitted access to a particular controlled access area. It may also be desirable to provide systems for managing who is permitted access to a controlled access area and for modifying the persons are permitted to access an area. Improvements to systems for controlling access to areas based on characteristics of the persons requesting access may be desirable.

It is also common for employees, contractors, or other persons to try and circumvent sanitization or access rules for a variety of reasons. Incorporating photographs or other biometric identifiers, or some sort of secure and easy to use identification system into systems controlling access into sensitive areas may be desirable.

### SUMMARY

The present disclosure relates to improved systems for controlling access and recording who has been allowed or denied access to controlled access areas. The present disclosure also relates to improved sanitization stations which control access to sensitive areas and records who has been allowed to enter and who has been denied entry to the area. The present disclosure also relates to improved sanitization stations providing greater safety and efficacy as well as efficient and clean operation. The present disclosure also relates to access control systems and stations that record attempts to access protected areas through the station, permit or deny access to the protected based on preset rules or permissions, and also record compliance with requirements for access to the protected area by authorized persons. The systems and stations may trigger local or remote alarms when an unauthorized person enters or attempts to enter a protected area, or fails to comply with conditions required to gain admission to the protected area.

### BRIEF DESCRIPTION OF THE DRAWINGS

The accompanying drawing figures, which are incorporated in and constitute a part of the description, illustrate several aspects of the invention and together with the description, serve to explain the principles of the invention. A brief description of the figures is as follows:

FIG. 1 is a perspective view of a sanitizing station according to the present disclosure.

FIG. 2 is a perspective view of a hand wash module for the sanitizing station of FIG. 1.

FIG. 3 is a top view of the hand wash module of FIG. 2.

FIG. 4 is a front view of the hand wash module of FIG. 2.

FIG. 5 is a side cross-sectional view of the hand was module of FIG. 2.

FIG. 6 is a diagram of a sanitizing station according to the present disclosure.

FIG. 7 is a diagram of a second embodiment of a sanitizing station according to the present disclosure.

FIG. 8 is a diagram of a third embodiment of a sanitizing station according to the present disclosure.

FIG. 9 is a diagram of a fourth embodiment of a sanitizing station according to the present disclosure.

FIG. 10 is a diagram of a fifth embodiment of a sanitizing station according to the present disclosure.

FIG. 11 is a diagram of a sixth embodiment of a sanitizing station according to the present disclosure.

FIG. 12 is a diagram of a seventh embodiment of a sanitizing station according to the present disclosure.

FIG. 13 is a diagram of an eighth embodiment of a sanitizing station according to the present disclosure.

FIG. 14 is a diagram of a ninth embodiment of a sanitizing station according to the present disclosure.

FIG. 15 is a diagram of a tenth embodiment of a sanitizing station according to the present disclosure.

FIG. 16 is a diagram of an eleventh embodiment of a sanitizing station according to the present disclosure.

FIG. 17 is a perspective view of a hand washing station according to the present disclosure.

FIG. 18 is a front view of a second embodiment of a hand washing station according to the present disclosure.

FIG. 19 is a front perspective view of a plumbing and materials storage module for a hand sanitizing or hand washing station according to the present disclosure.

FIG. 20 is a front perspective view of a control module for a hand sanitizing or hand washing station according to the present disclosure.

FIG. 21 is a perspective view of a plurality of a first embodiment of an RFID transponder and bracelet according to the present disclosure.

FIG. 22 is a perspective view of a second embodiment of an RFID transponder and bracelet according to the present disclosure.

FIG. 23 is a perspective view of a sanitizing and access control station according to the present disclosure.

FIG. 24 is a perspective view of a self-contained sanitizing and access control station according to the present disclosure.

FIG. 25 is a front view of the sanitizing and access control station of FIG. 24.

FIG. 26 is a side view of the sanitizing and access control station of FIG. 24.

FIG. 27 is a rear view of the sanitizing and access control station of FIG. 24.

FIG. 28 is a front cross-sectional view of the sanitizing and access control station of FIG. 24, taken along line B-B.

FIG. 29 is a top cross-sectional view of the sanitizing and access control station of FIG. 24, taken along line A-A.

### DETAILED DESCRIPTION

Reference will now be made in detail to exemplary aspects of the present invention which are illustrated in the accompanying drawings. Wherever possible, the same reference numbers will be used throughout the drawings to refer to the same or like parts.

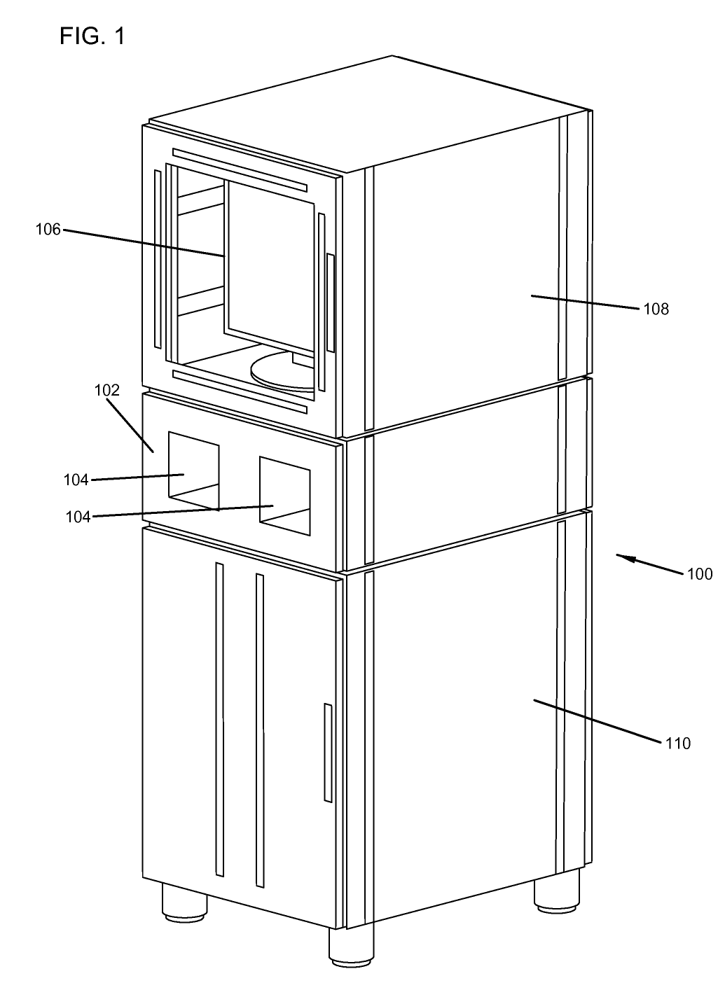

As shown in FIG. 1, a hand sanitizing station 100 includes a hand wash module 102 with a pair of openings 104 for insertion of a person's hands. Above module 102 is a screen or display 106 mounted within a display and control module 108. Beneath module 102 is a storage and supply module 110. By compartmentalizing the different functions within sanitization station 100, it is possible to move different components into different areas without affecting the overall operation and functioning of the station.

It is anticipated that most or all of the control and logic systems driving operation of the station may be housed within module 108. While these control and logic functions may be primarily composed of solid state components, it may be necessary or desirable to move module 108 to a location shielded or physically removed from the other two modules for fire hazard avoidance. Similarly, it may be desirable to have module 110 placed remotely from the other two modules to isolate bulk materials and refuse from any potential fire hazards.

The caution in the location and isolation of elements described above may be desirable based on the nature of the material used to sanitize the user's hands. As presently configured, the material used to sanitize hands is an alcohol based liquid that is sprayed onto the hands and which quickly evaporates. Known liquids of this type have flashpoints that close to room temperature and may, in some circumstances be classified as a fire or explosion hazard. Since sanitization station 100 may be placed adjacent or within an exit corridor of a facility, it may desirable or required that the bulk storage module including the alcohol based liquid be located somewhere removed from the hand module.

Placing all electrical or electronic controls within module 108 may allow them to be shielded and protected from generated a spark or arc that might tend to ignite any nearby flammable vapor or liquid. Even with these safeguards in place, it still may be desirable to separate module 108 from module 102.

Module 108 is also shown including display 106 where instructions for operation or other messages may be displayed or relayed to the user. Information regarding how to use the station, or the required sequence of steps to gain access to the protected area may be displayed. Once an employee has approached the station and requested access to the protected area requiring the sanitizing functions, the user may be required to present identification materials before the process can begin. Upon presentation of identification, the user's identification materials may be echoed on the screen for verification. Additional features or capabilities of the identification process are also described below.

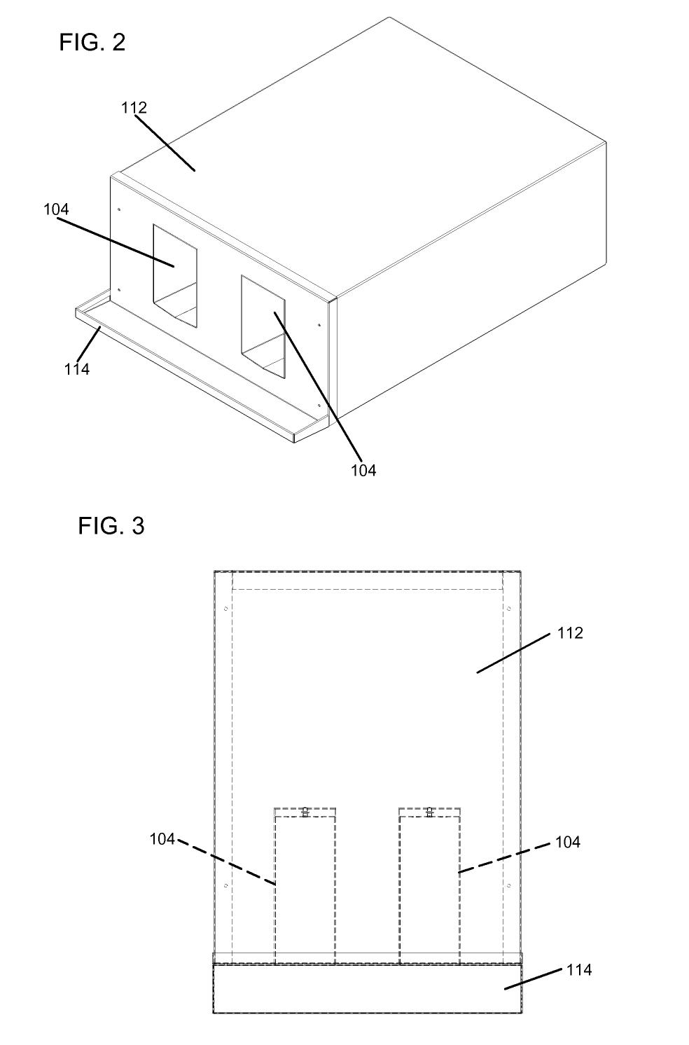

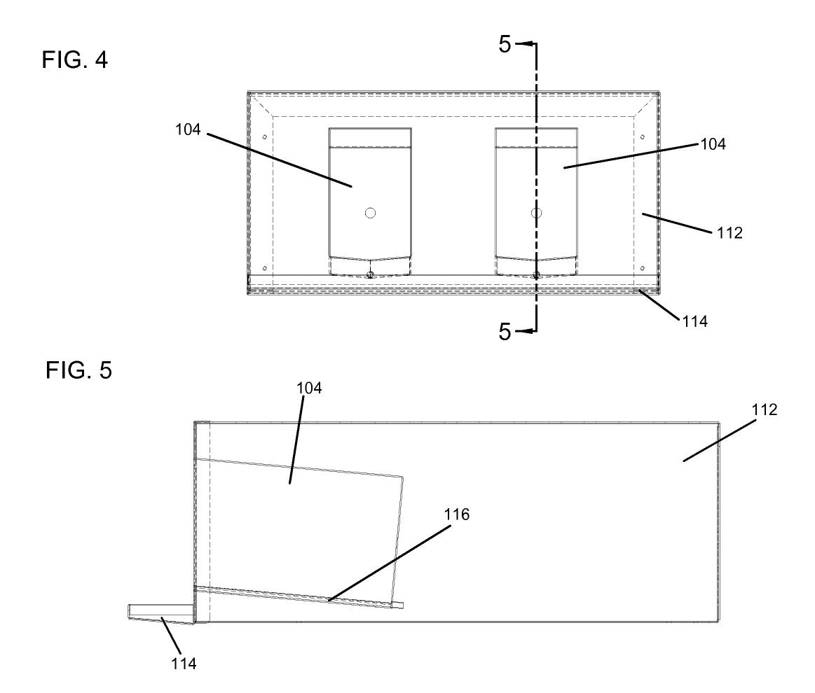

FIGS. 2 to 5 illustrate a housing 112 for module 102 with openings 104. A catch tray 114 is positioned directly underneath openings 104 so that excess fluid clinging to a user's hands as the hands are withdrawn from the openings may captured before dripping onto the floor. Excess fluid dripping on the floor may create an undesirable slip-and-fall risk and should be avoided if possible. Within openings 104 and defining a base to the cavities behind openings 104 is a sloped floor 116, as seen in FIG. 5. Floor 116 also serves to capture and retain excess fluid and prevent fluid from exiting module 102.

In operation, a user would insert his or her hands within openings 104 into module 102. When the hands are properly positioned within the housing, a mist of sanitizing fluid is sprayed over all sides of the hands as the user withdraws their hands from the openings. The fluid is selected as one of currently known quickly evaporating fluids, which are primarily composed of alcohol. As the user withdraws his or her hands, the fluid rapidly evaporates, and the process of evaporation may be helped by the user rubbing his or her hands together.

A variety of methods may be used to actuate the spraying of a user's hands within module 102. Touch sensors, proximity sensors, light beam sensors, and light curtain sensors are just a few, non limiting list of examples of sensors that might be used to determine when a user's hands are positioned within openings 104. Alternatively, an external switch could be mounted for actuation by the user, such as a foot switch. A further alternative might be a combination of an externally actuated switch with sensors to verify that a user's hands are indeed in position prior to initiating spraying within openings 104.

It is anticipated that station 100 might be configured to include a boot or foot sanitizing module that is controlled by module 108 and also possibly supplied by module 110. While such a boot or foot station is not shown, it might be configured to blanket all or a portion of the user's shoes with a similar sanitizing material, whether the shoes are inserted within enclosures or merely positioned on designated spots on a floor module. Again, sensors might be provided that sense when one or both feet are correctly positioned for spraying of the shoes.

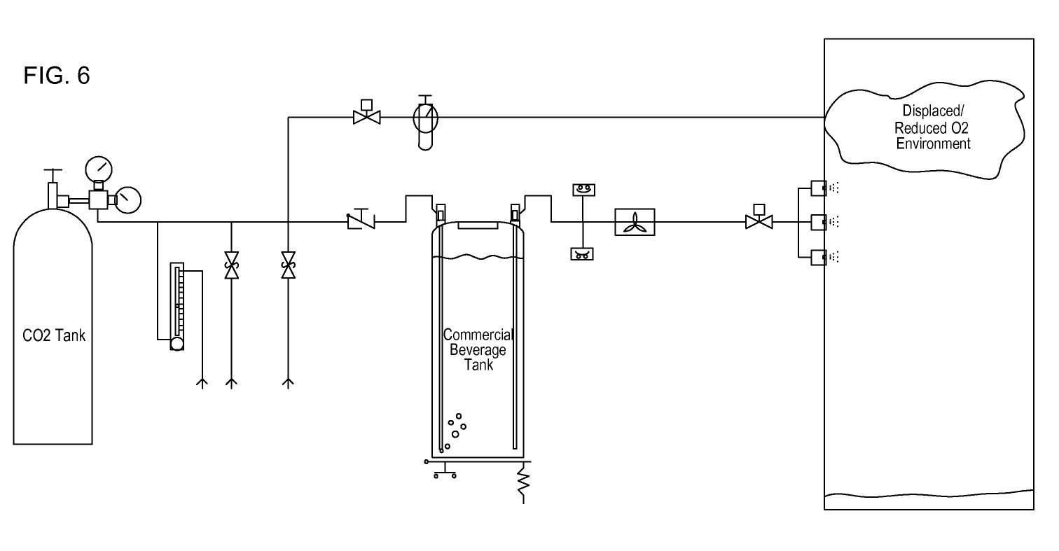

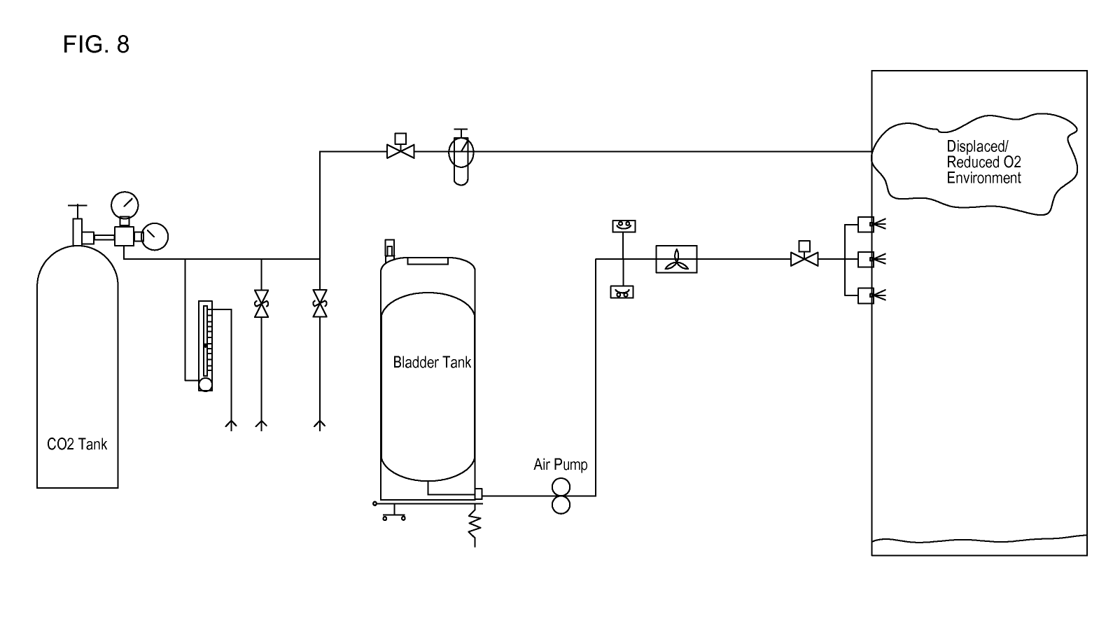

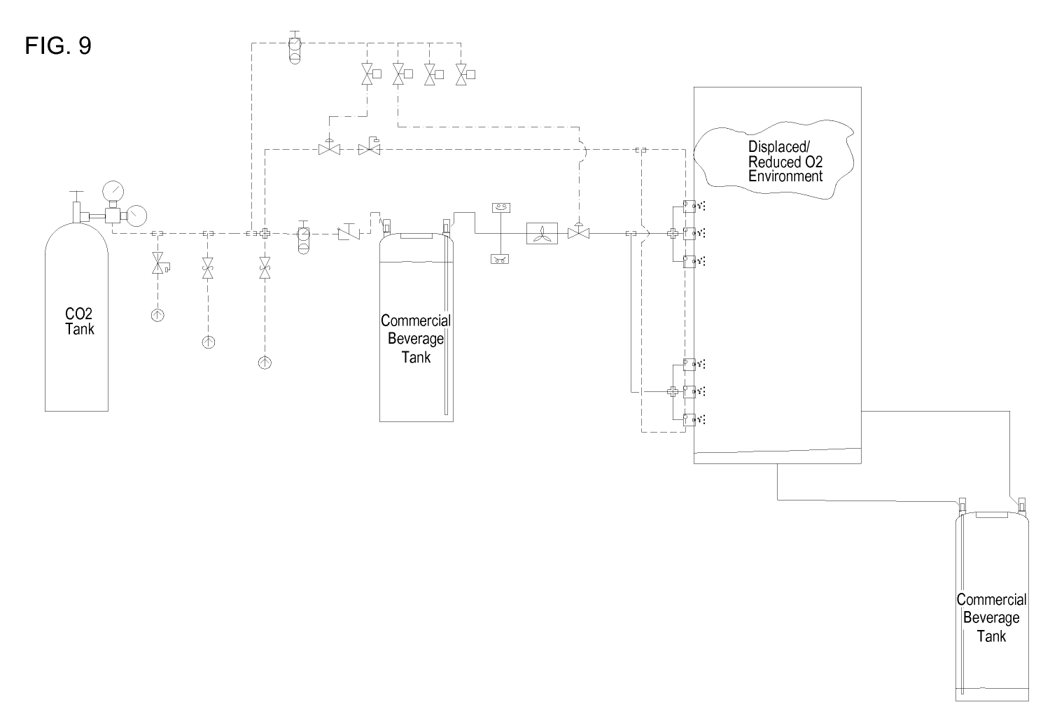

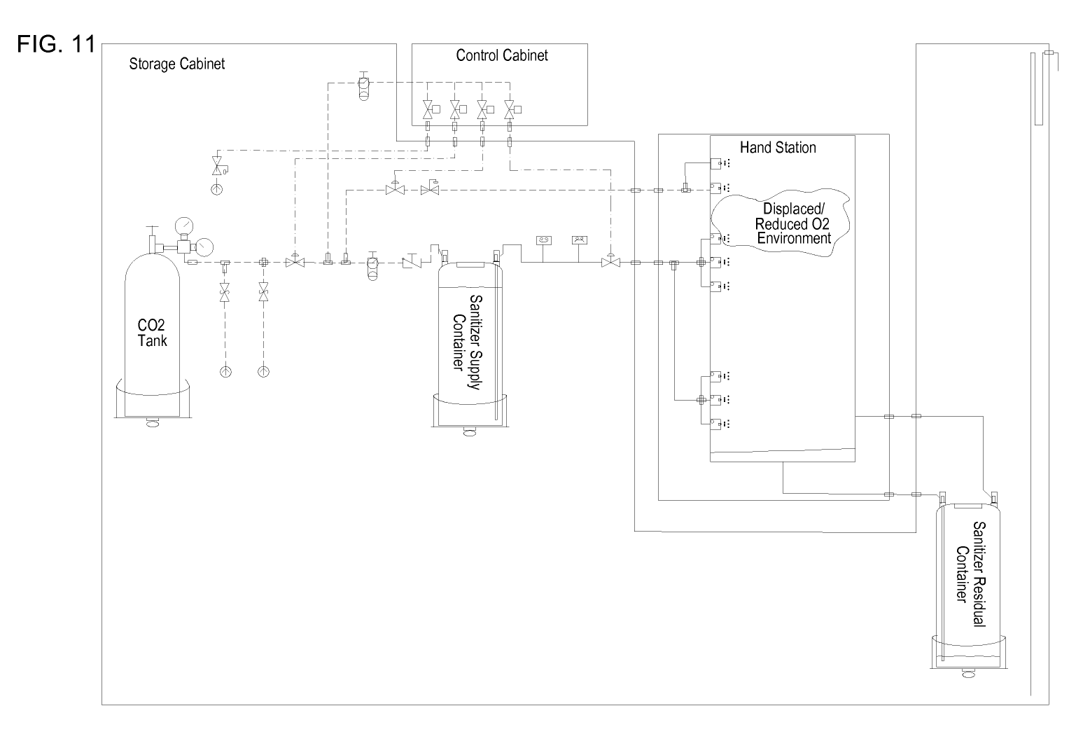

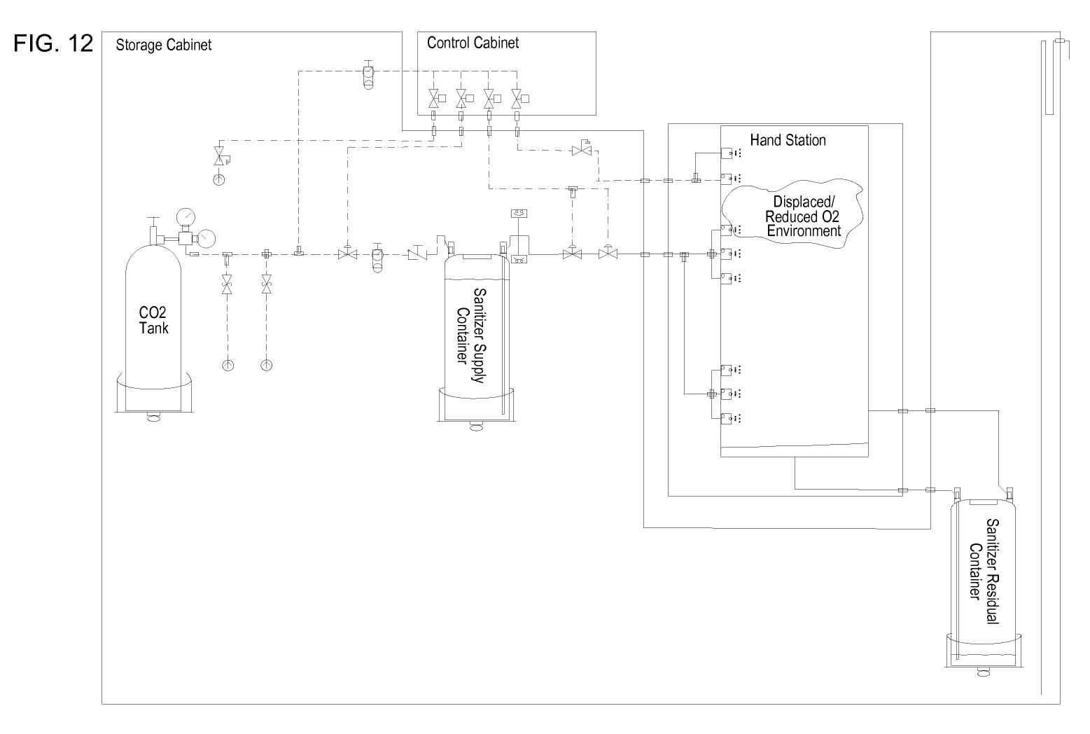

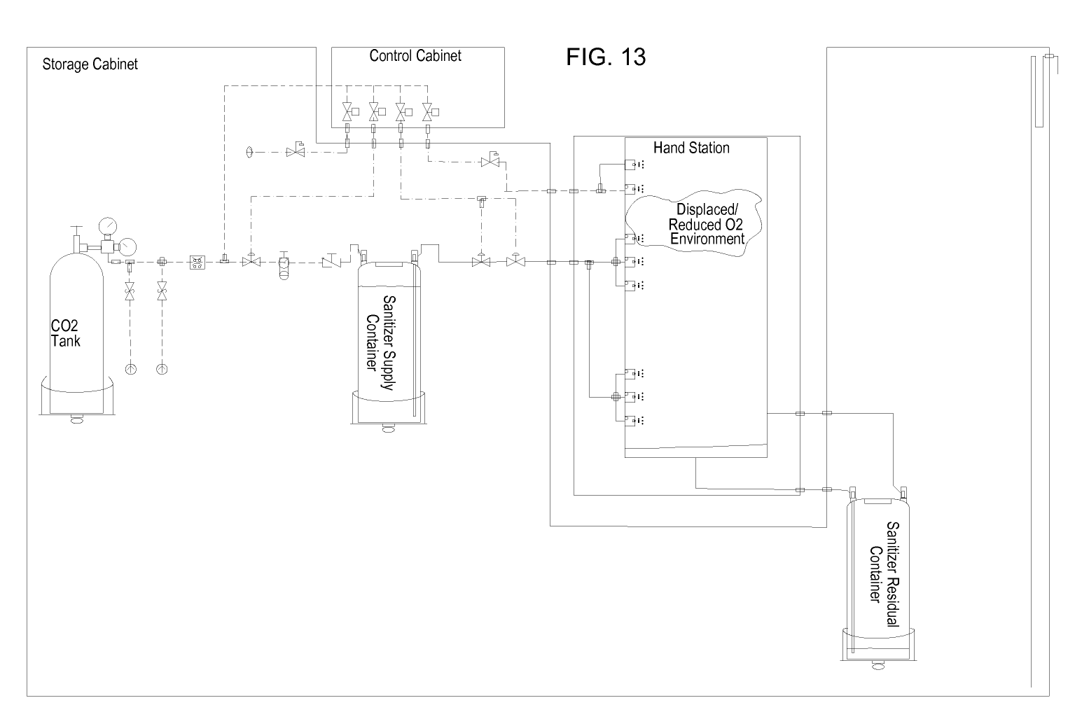

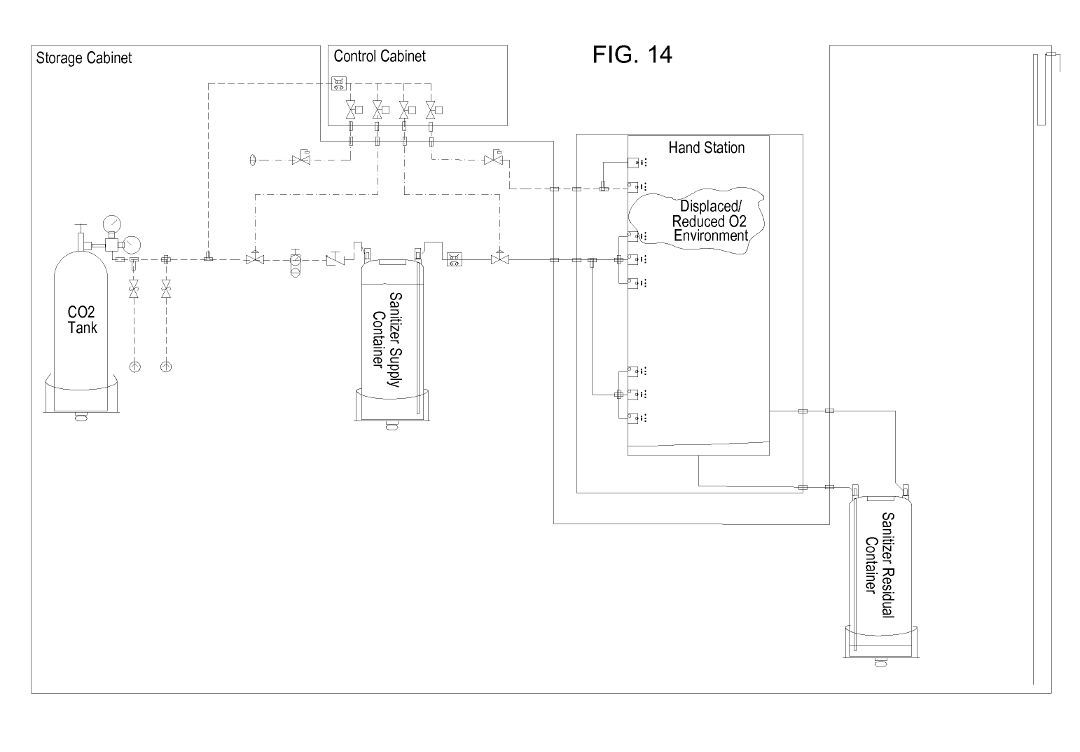

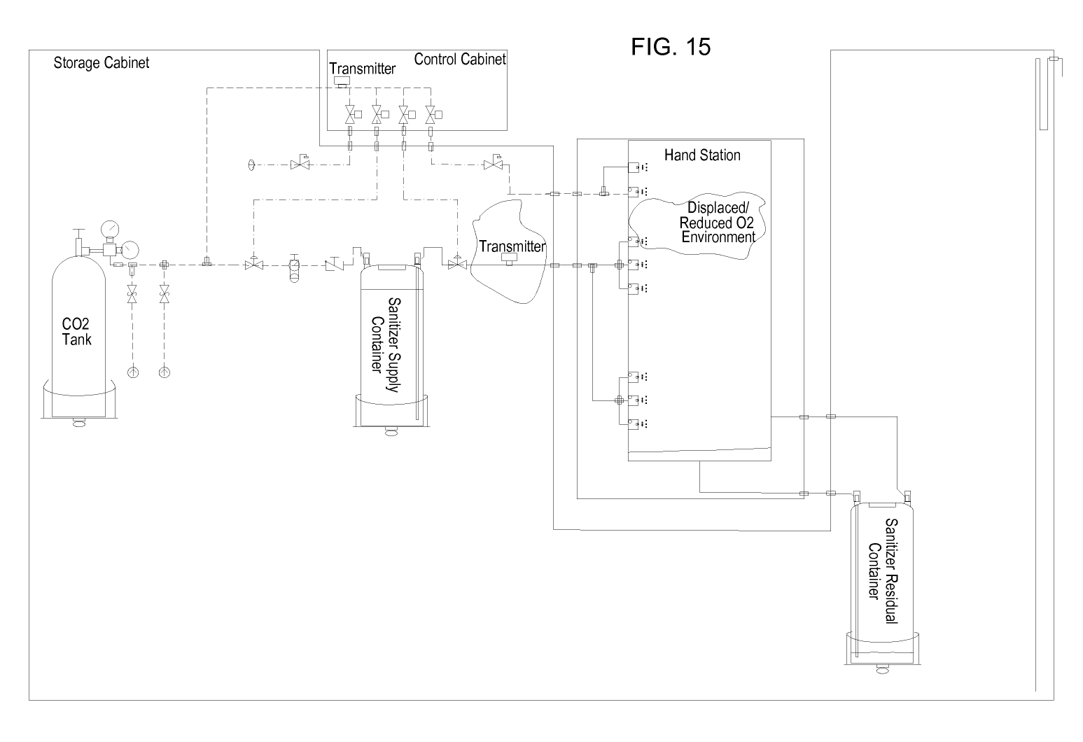

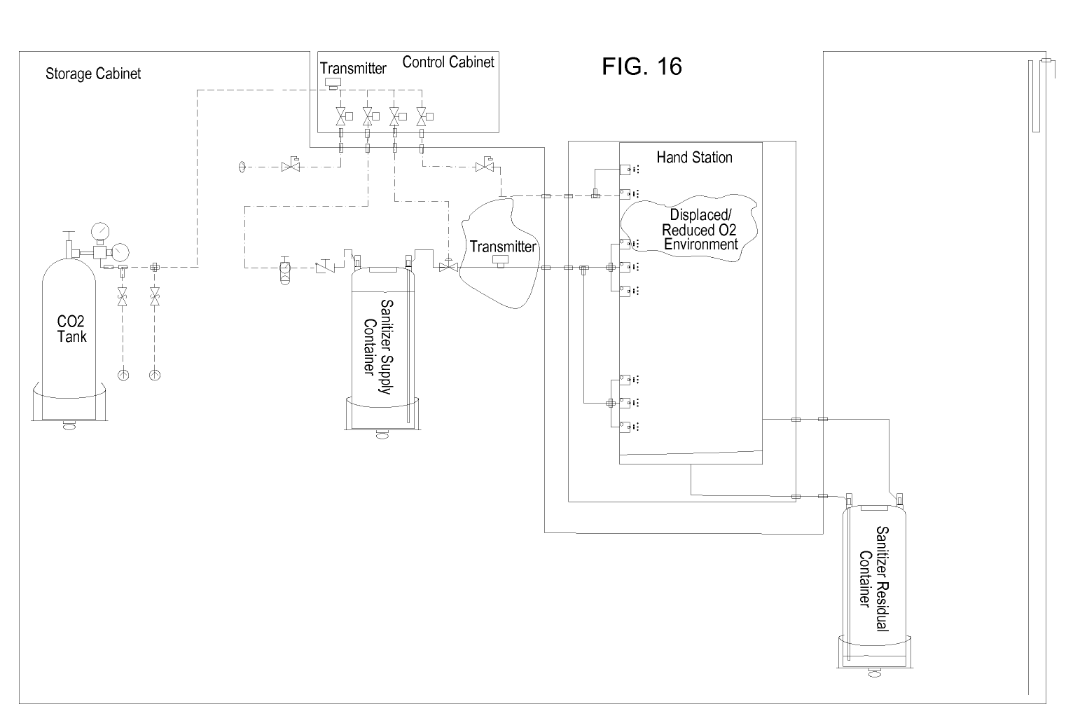

Regardless of how different portions of station 100 may be categorized and/or compartmentalized, there are variety of possible configurations of the components that can be used in station 100. These are shown variously in FIGS. 6 to 16.

These various embodiments vary in components and configuration, but include several common elements. While a plurality of embodiments are shown, this list is not intended to limit the extend to which the concepts and features of the present disclosure may cover. Each of the illustrated systems are pressurized by an inert gas, preferably a commonly available gas, such as carbon dioxide. Pressure from the gas may be used to drive a conventional sanitizing material from a reservoir or bulk container through a fluid connection to one or more spray nozzles located adjacent the object needing to be sanitized, for example, a user's hands or feet.

One issue with conventional spray nozzle arrangements when used with conventional alcohol-based sanitizing compounds is that the compounds have such a low flash point when sprayed, that the nozzles would eject flaming jets of the compound. Using an inert gas such as carbon dioxide in the pressurization of the dispensing systems can help displace some of the oxygen that might otherwise be available for supporting the combustion of the compound spray. Additionally, the gas can be pumped or flooded into an enclosure when the spraying is to take place, for example, openings 104 of module 102. Within the spray enclosure, the gas can create a displaced or reduced oxygen environment which may serve to reduce or eliminate the combustion of the compound spray.

Use of an inert gas such as carbon dioxide may also help provide a fire suppression feature to the bulk storage module of systems according to the present invention. Within module 110, where the alcohol-based compounds and the bulk gas container may be stored, pressure and heat sensitive relief valves may be included in the gas plumbing. If module 110 is exposed to fire or excess heat, these temperature and pressure relief valves may vent some or all of the contents of the gas container into an interior of module 110. This blanket of inert gas within the module may serve to extinguish any local flames or help protect the interior from encroachment of flames from outside the module.

Due to the role of the gas within the system of the present disclosure, it may be desirable to include a flow shutoff for sanitizing compound which engages when pressure within the gas container or of the gas within the plumbing drops below a certain predetermined level. This will help ensure that proper sprays are dispensed when a user goes through the sanitizing process and that proper safety and protection of the user of the system is maintained.

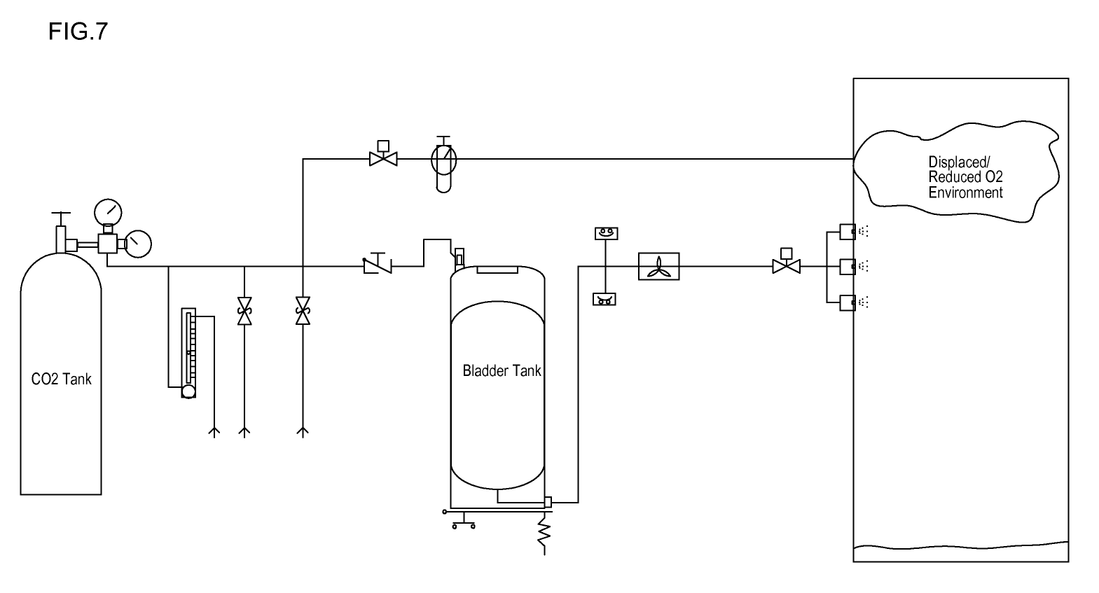

Bulk sanitizing compound containers may be pressurized by a gas blanket, as shown in FIG. 6, or may include a fluid bladder with the gas acting on an outer surface of the bladder, as shown in FIG. 7. Purge valves may also be included in the gas plumbing of a system, allowing excess amounts of gas to be exhausted into module 110.

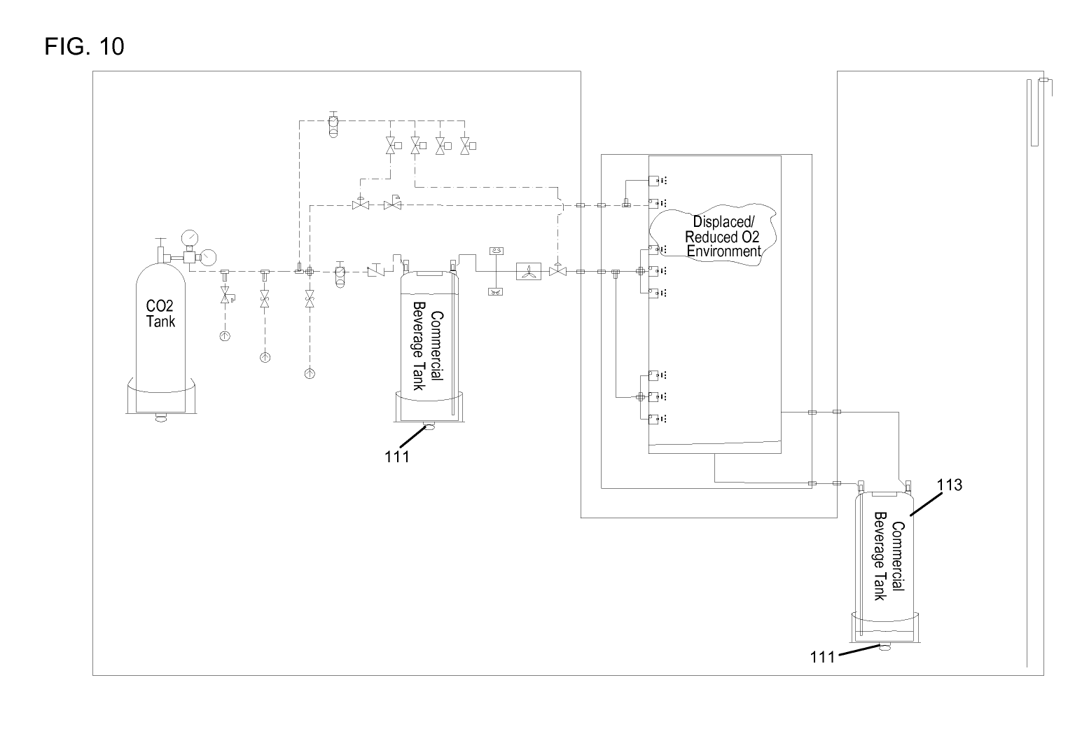

As shown in FIG. 10, one or more scales 111 may be included in systems according to the present disclosure to determine when gas or compound levels are sufficient or if they need to be replenished. Shutoff may be actuated by the scales recording weights below certain preset values for either the gas or the sanitizing compound. It is also anticipated that scale 111 could be included with a sanitizer residual container 113, and used to provide warning when the residual sanitizer amount requires the emptying of container 113.

The valves, valve actuators, solenoids and other plumbing elements shown in the FIGS., other than those indicated as being within the bulk storage module, or within the hand wash module, may all be concentrated within the control module. This centralization of the components may provide advantages with respect to manufacturing efficiencies or maintenance efficiencies. Such an arrangement may also aid in addressing fire code issues relating to locating electrical components adjacent to or near the bulk storage of a flammable material such as an alcohol-based sanitizing compound.

One item not expressly shown in the FIGS. but which is intended to be a part of the present disclosure, is a means of identifying the person who is before the station requesting access to the protected area. Such a means may include use of photo ID badges or other specific ID badges that employees often carry which may inserted within or swiped across a reader of some sort. Alternatively, such an ID process might include radio frequency identification (RFID) elements, where a person needs only bring an RFID identification transponder within a certain range of the identification means. Once a user has presented him or herself to the station requesting access, the station may include a camera for taking a facial image to compare against a known facial model for the person associated with the presented ID. In this way, the station or other access control station according to the present disclosure may be able to verify that the person standing before the station matches the presented identification. Other identity verification tools, such a finger prints, palm scans, retinal scans, or other biometric identification tools may be incorporated on the station.

It is also anticipated that a station according the present invention may include a plurality of tools to identify and catalog individuals presenting themselves for entry. As an example, employees of the company implementing such a station may have standard employee ID cards which the station can read. Frequent visitors or vendors who may be allowed into some or all portions of the protected area may be provided with similar ID cards but which may allow for more limited access to facilities, information or equipment. Infrequent or one-time visitors may be able to use a credit card or drivers license to establish a record of their visit and to begin recording information regarding where they were allowed to go and what sorts of sanitization or instructional features they were exposed to. For example, a once a year visitor might establish a record of their first visit using a credit card, and that record might include that the visitor was granted access to a particular zone of the protected area and that the visitor was properly sanitized prior to the visitor being allowed into the area. If the same visitor comes back to the same protected facility or a similar linked facility, a swipe of the same credit card would access the record to see if the visitor was exposed to any safety briefings or tests that might be required to enter a different area in the same facility, or to visit the same area if the requirements for accessing the area have changed since the last visit.

Such identification cards or other personal identifiers that may be used to record the presence and identity of the person approaching the access control station may be conventional proximity cards, cards including encoded material that can be read by swiping the card through a reader, or any other type of suitable of data capture device. Preferably, the data capture device will involve little to no user interaction to perform the capture of information from the identifier.

It is anticipated that a person would not necessarily be limited to a single form of identification that may be presented to the control station. A particular user record in a database attached to and supporting operation of the system may include one or a plurality of different permissible identification types. The user record may also indicate if the user is permitted to visit a limited number of areas, and/or what limitations may be placed on the user's access to particular areas. Inclusion of the display into an access control station may permit the station to query that user for particular pieces of information needed prior to permitting access to a controlled area. The display may be used to provide information videos or test for particular items such as auditory or visual acuity. Such an access control system may be networked with a variety of similar stations about a particular facility or may be linked to a central database or reporting infrastructure for reporting exceptions arising during screening operations.

It is also anticipated that the present access control system may not incorporate sanitizing characteristics but be used as an area access control device. Infrared or other types of remote body temperature sensors could be incorporating into such a system to test for potentially infected or diseased persons being permitting to access certain controlled areas. While the temperature might be used to immediately screen out an individual from accessing a protected area on a particular day, it is anticipated that such medically related information will only be kept temporarily as needed to control access. For example, a daily record of temperature may be kept for individuals accessing an area so that short term trends in body temperature can be identified. After a short time period, for example, a week, the temperature data previously collected may be deleted or expunged from the database as no longer having any relevance to determining whether the individual should be allowed to access a protected area.

Some form of body weight sensor could be included in the area access control functions as well. By verifying a person's weight when they present themselves or their identity credential requesting access, several functions may be accomplished. First, it can serve as some rudimentary check or verification of identity, by confirming against a database of recorded weight at the time the credential was issued or a most recently recorded weight (for example, at the last requested entry). Secondly, it may also be used to verify health condition of an individual, with adverse health consequences be interpreted from a pattern of rapid weight drop. Additionally, by collecting a weight measurement for each person on entry and exit from a controlled area, whether material is being taken into or removed from the controlled area may be inferred.

While much of the discussion above has been directed at controlling access to particular areas, it is also anticipated that the same processes, systems and mechanisms may be used to sanitize or verify exit of persons from controlled areas. Sensitive laboratories where noxious, dangerous or contagious materials are handled may have a requirement for cleansing or sanitizing upon exit from the protected area. Verification of such exit procedures may also be accomplished according to the present disclosure. Removal of material from such protected areas may be determined with incorporated weight sensors and comparing entry and exit weights. Potential infection of a person within the protected area may be determined by comparing entry and exit body temperatures.

In the interest of providing redundancy and security in the reporting and recording of entry to and exit from a controlled access area, the present disclosure may be implemented with a cellular mesh communications network and/or in a remote data collection and reporting function. Removing the recording and reporting of access records and any exceptions from the protected facility may provide a greater degree of auditable security for an owner or operator of such a facility. Human error in the recording and reporting can be more tightly controlled and nefarious efforts to defeat the local security may be made much more difficult be remotely locating these functions.

Such a remotely managed access control system may be used to provide reports back to the facility being protected. Data transfer speed and reliability may be issues for such remote management of systems, so several strategies may be employed. One example might have immediate notifications to the managers or security of the protected facility of any attempted access by prohibited persons, or denials of access to otherwise allowable persons. A more complete report of the days activities could be compiled and transferred at a later time, such as at the end of each day, or each week, or some other periodic or regular interval. Such a system might be termed management by exception, as only the non-ordinary or unexpected events trigger an immediate notification so that local managers or security may address the situation. The accumulated information that may be contained in the later supplied reports may be necessary for auditing or otherwise ensuring and verifying compliance with standards and rules related to controlling access to an area.

Another use for such accumulated reports may be to track who did have access to an area to perform, for example, a forensic investigation. The controlled area may be used, for example, to produce baby formula. Each person entering the area is required to present credentials and be verified as a person permitted to enter the area. Once identity is verified, the person may then proceed through a contamination testing and/or sanitization process before being allowed to enter the protected area. Such process may also be recorded with the record of that person entering the area. In the event that contamination of the product generated within the area is discovered at a later date, the reports of who had access to the area when the product was produced and verification that they did proceed to the testing and/or cleaning process may help determine the cause of the contamination.

For example, a person permitted entry to an area may subsequently develop symptoms of a contagious disease that had not presented itself at the time that entry to the area was permitted. If the person was contagious while within the protected area, the product may have been contaminated with the disease. Consumers of the product may subsequently contract the disease. A forensic investigation may review all employees or other person having access to the area while the product in question was produced and then determine if any of the persons having access later exhibited symptoms of the disease caused by the product.

This information regarding control of access and sanitization or testing done prior to admittance to a protected area may be used to defend a claim of negligence on the part of the manufacturer of the product. Such information may show that the manufacturer took all reasonable prudent steps to protect against contamination and may provide an audit trail of such activity. If there is a question as to where in a production, packaging and shipping cycle that the product may have been contaminated, this information may help eliminate the protected area as a probable source of the contamination. If the forensic investigation determines that some person may have intentionally introduced a contaminant into a product stream, an access control system according to the present disclosure may be useful in determining if and where that person may have had access to the product.

In the current environment with great concern over terrorism and other malicious acts, such an access and monitoring system, coupled with recordkeeping and reporting related to access may have great value in preventing such acts and investigating any such acts that do occur.

A remote monitoring and reporting system according to the present disclosure may control access to a plurality of protected areas and report activity at each of these areas to one or more central monitoring or management facilities. Such a multi-facility system with centralized monitoring and control may ensure that standards regarding access are maintained across an entire organization. Such a system may also provide management with real-time data and information on operations and activity across the organization and permit dissemination of updated standards and controls back to the individual facilities in a timely and controllable fashion. Local variances in control and management of access control may be reduced and a common level of security may be enforced. Problems at any one facility may be quickly compared against activities at other facilities to determine if an issue may be random or specific to one facility, systematic and affecting multiple facilities similarly, or even a coordinated activity affecting one or more facilities.

While some of the above discussion has described widely separated facilities which are commonly controlled and monitored, a system according to the present invention may also be used to control and monitor multiple points of entry to the same facility. Larger facilities may require a plurality of entrances into a protected area and access to the protected area through any of these entrances may be controlled and coordinated according to the present disclosure. Alternatively, within the facility, there may be different areas to which access may be controlled but which have different standards or requirements for permitting entry, or into which different sets of persons are allowed. Each of these controlled access areas may be protected utilizing the system of the present disclosure and the systems protecting each of these different areas may be centrally monitored and controlled by the same location, as described herein.

It is also anticipated that changes may be made to the nature of access permitted or the persons permitted to access a controlled area on an ad hoc basis and that such changes may be quickly implemented at any protected entrance remotely by the remote management and control system. Examples of access control changes to be made may be in response to an emergency situation and may be relatively short-lived in nature. Another example of an ad hoc change may be for access to an area where access is controlled according to national security rules. A change to the National Threat Advisory Level may require changes to the nature of access permitted to the facility. The ability to implement such a change to access quickly and uniformly across all protected areas in response to the threat advisory level may be extremely valuable.

It is also anticipated that a particular facility may have a variety of controlled access areas and that each of these areas may have different criteria as to who is allowed to enter the areas and on what conditions they may enter the areas. While there may be overlap in the criteria used to determine whether a person is admitted to each of the different areas, each area may have one or more unique requirements for entry. While each of the areas may not require any sort of sanitization, each of the areas may have access control points which are configured according to the present disclosure.

As a non-limiting example, a first visitor might be allowed only into certain public areas within a facility. A second visitor who has received some degree of emergency training or evaluation may be allowed into the public areas and also into some other areas such as manufacturing or assembly areas. A third visitor may be permitted into certain engineering and administrative areas with an escort and otherwise be restricted to the public areas. Administrative employees may be allowed access to office areas but restricted from access to certain manufacturing or engineering areas. Most employees may be prohibited from accessing areas where employee records are maintained. Certain manufacturing or engineering areas where secret or proprietary work is carried out may be restricted for all employees except those authorized to be involved in the work. Certain employees may require access to all areas of the facility to ensure compliance and auditing of operations.

Visitors may be permitted access to certain areas of the facility only after having viewed certain emergency response training materials, or having passed certain visual or auditory acuity tests, to ensure that they can see or hear warning signals. If an area that a visitor is accessing requires eye or hearing protection, the access control system may include a dispenser of the appropriate devices when the visitor presents him or herself for admittance. A record can be kept of any training or assessment performed by the visitor so that on future visits to the same facility, the visitor may not need to redo the testing or training. Such a record can also be used to determine if a person seeking access to an area needs to have refresher training or testing, or if the person has received the latest version of the training or testing. Compliance with new or amended training or testing for access to a particular controlled access area can be enforced and audited with an access control system according to the present disclosure.

Changes can be made to a particular class or group of employees regarding the areas to which they are permitted to enter using a system according to the present disclosure. Changes may also be made to permit or deny access to one or more areas for a particular person, even while that person is within the facility. Warnings, reminders, alerts or other messages may be displayed by an access control system to any person when the person presents their credentials for entry to a controlled access area. If there is a need to ensure that a person has had access to or been presented with a warning, reminder, alert or other message, a system according to the present disclosure may record when and where the person was presented with the information.

A camera may be incorporated into the access control unit at the point of entry visited by the person, an image of the person may also be attached to the record of the person's entry into the area. Verification can then be made at a later date that the person presenting credentials for entry matches the identity of the credentials and that the person was presented with the warning, reminder, alert or other message. If a person is admitted to a controlled access area using someone else's credentials, this may also be verified by using imagery from an integral or attached camera. Some form of biometric analysis software or system may be incorporated into the access control system so that comparison of identity and credentials of identity may take place before the person is permitted to enter a controlled access area. Attempts by persons to use incorrect or non-matching credentials to gain entry to a controlled access area might trigger also an immediate exception or activity alert to a centralized or remote monitoring location or system. Local security personnel may also be alerted to detain and question the person attempting entry with incorrect or non-matching credentials.

Specific conditions may be enforced for passing between particular controlled access areas. Concerns, for example regarding cross-contamination of products or material, or cumulative exposure of employees to multiple hazards or environmental conditions, may be addressed by preventing a person from passing sequentially between specific areas of the facility. By having controlled access to a variety of areas of the facility, some rudimentary or even detailed tracking of employee movement or visitor movement through a facility may be enabled. Such tracking may be of great importance in a forensic investigation, as discussed above. When an employee or visitor is inside a controlled access area, it may also be possible to track proximity or location of the person within the area through use of RFID transponders and sensors.

A cellular-based mesh communications network incorporated into an access control system at a protected facility may take the security to a higher level by removing the communication and control of the local operation to communication medium completely independent from the telecommunications infrastructure of the protected facility. Implementation of such a mesh network may provide a greater degree of autonomy of operation and function of each device incorporated into the access control network by ensuring that the removal of any one or more devices from the network will not prevent the other devices from communicating with a remote monitoring facility. While this mesh network has been described as cellular-based, other forms of wireless or secure telecommunication may be used to connect the protected facility with a remote monitoring location.

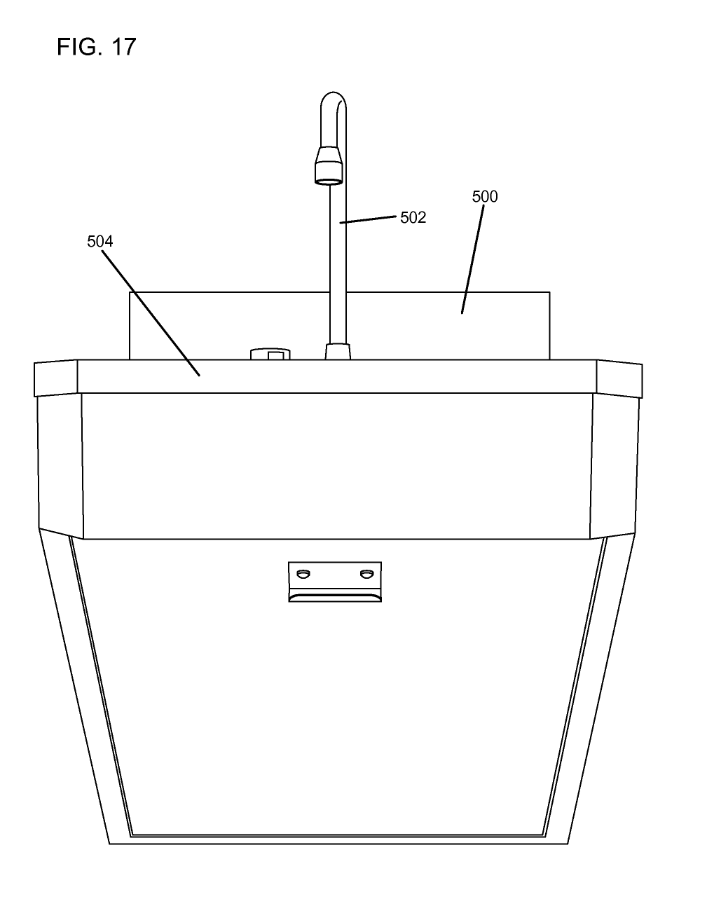

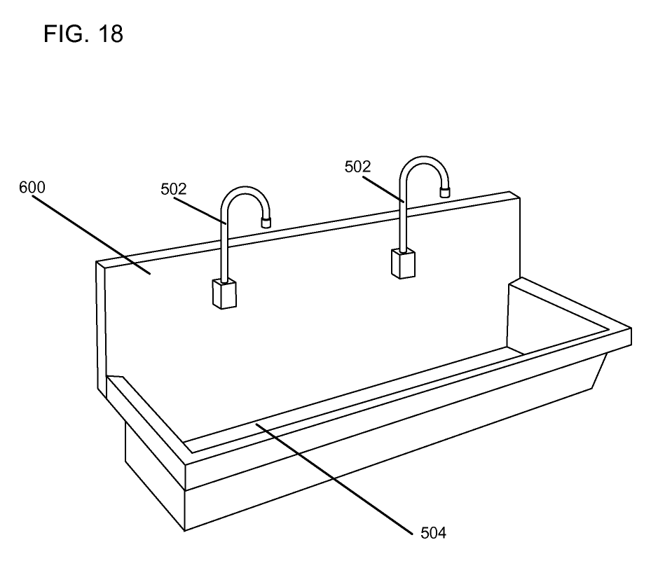

It is anticipated that different embodiments or versions of hand sanitizing stations, or other similar check points or access control points may be constructed in a modular fashion to separate functions into discrete units which may or may not be commonly located. An example of this sort of arrangement is illustrated in FIGS. 17 to 20. In FIGS. 17 and 18, two different embodiments of hand washing stations 500 and 600 are shown. Stations 500 and 600 may be configured as traditional hand washing stations or they may dispense the alcohol based hand sanitizing solution described above.

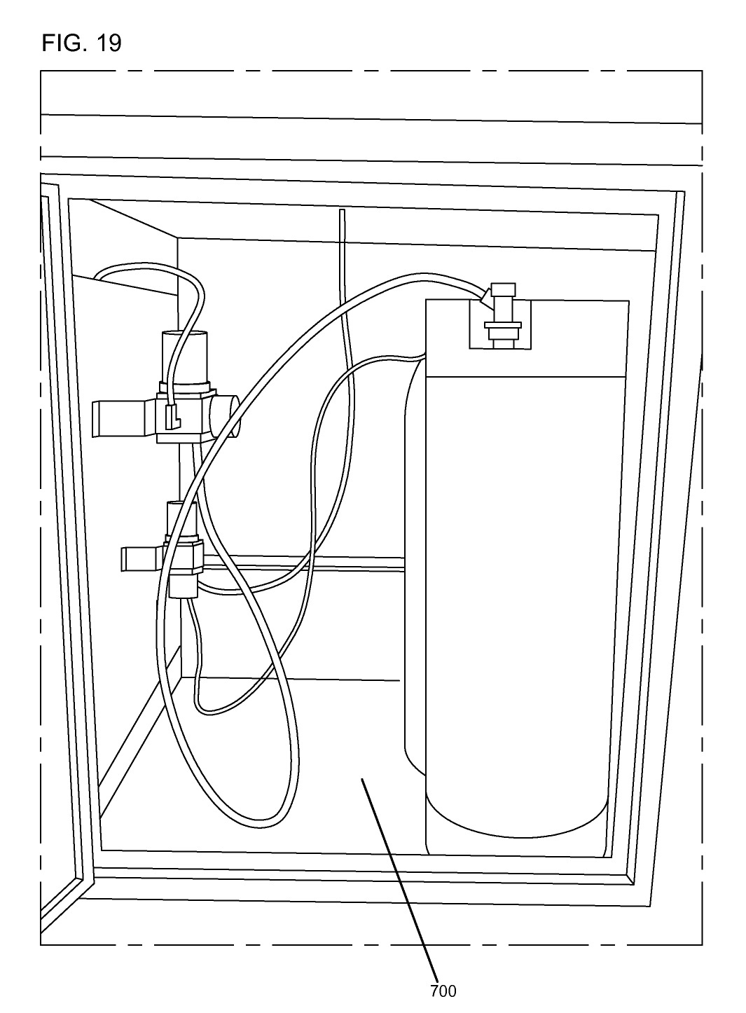

FIG. 19 illustrates a plumbing and materials storage module 700 which may be configured to deliver appropriate amounts of sanitizing liquid with the appropriate amount of inert gas preventing or suppressing any fire dangers associated with the atomized delivery of the sanitizing liquid. Module 700 may be located directly adjacent to either station 500 or 600 if space and/or safety conditions permit. Alternatively, module 700 may be mounted within a required safety enclosure or on another side of a fire or safety wall from the stations. Module 700 as shown does not include electronic components within an interior of the module to reduce any danger of ignition of any liquid or fumes within the interior. Note that if non-flammable sanitizing materials are being dispensed by the connected hand washing or sanitizing station, electronic components or controls may be housed safely within the interior while remaining within the scope of the present disclosure.

Within the interior of module 700 are shown two containers, one each for the sanitizing product and another for the inert gas. Both are easily accessible through an opening of the module, permitting removal and replacement, or recharging of the containers. As shown, the valves within module 700 are actuated by gas pressure derived from the pressurized inert gas container. Alternatively, an exterior source of vacuum or gas pressure may be provided to actuate the valves controlling the flow of sanitizing fluid and gas from module 700 to station 500 or 600.

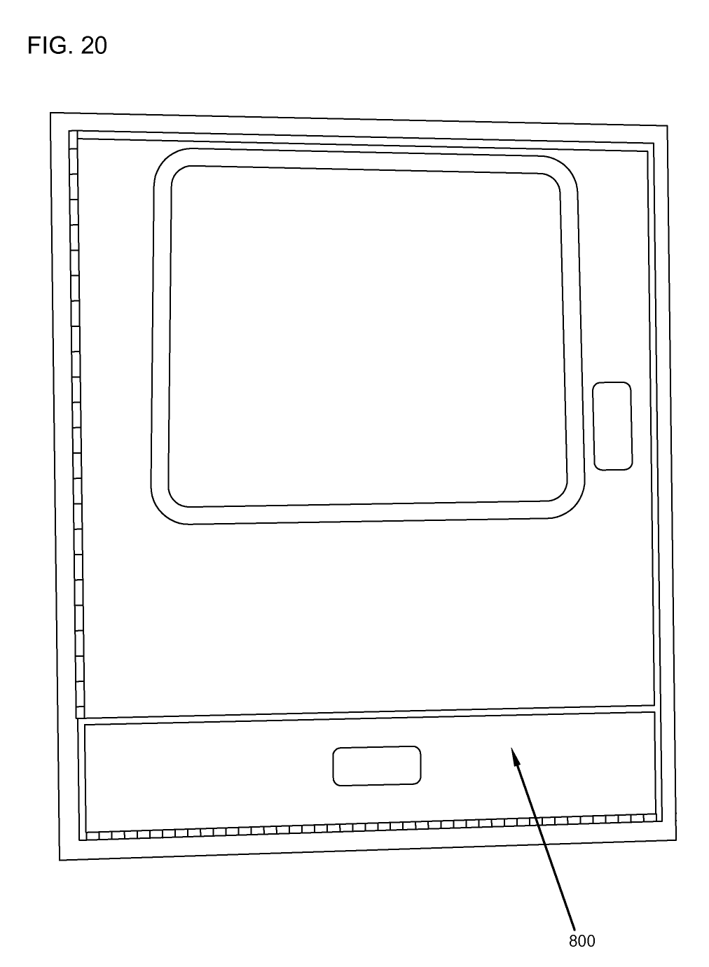

FIG. 20 shows a control and processing module 800 for use with stations 500 or 600 and materials module 700. Control module 800 may include the electronic controls for actuating the valves or other devices housed within materials module 700. Control module 800 may also contain any data collections and processing apparatus as well as devices to communicate information received, collected and/or processed by control module 800. As shown, control module 800 is a sealed housing to prevent infiltration potential dangerous or explosive vapors that may be generated by the other modules or stations. Electrical shielding may also be provided by the housing to prevent any electro-magnetic fields from adversely affecting the electronic components inside the housing.

As shown in FIG. 1, station 100 may incorporate all three of the different modules into a single, self-contained unit. FIGS. 17 to 20 illustrate how the modules may be separated and remotely located with respect to each other to isolate different features or functions of the sanitizing or access control functions.

As shown in FIGS. 17 and 18, hand washing modules or stations 500 and 600 may include faucets or other liquid dispensers 502 that are activated by the proximity of a person's hand to the dispenser. Such hand activated faucets typically have a sensor incorporated into some portion of the faucet extending above a sink or basin 504. When a user's hands are within range of the sensor, and thus positioned beneath the faucet, flow of water or some other sanitizing or cleaning fluid may be initiated. The fluid flow may continue for a set period of time to dispense a desired quantity or fluid or may continue for as long as the user's hands remain in proximity to the sensor, or combinations of time, quantity and proximity, or any other relevant conditions.

It is anticipated that the washing station 500 or 600 may also incorporate a sensor to record some identifier of the user whose hands are beneath the particular faucet. Such an identity sensor might be co-located with the flow proximity sensor or may be positioned at some other appropriate location to capture information regarding the user. In conjunction with a sensor mounted adjacent the wash stations, a user may be required to wear or carry a radio-frequency identification device (RFID) transponder. The identity sensor would send out a particular radio signal that the RFID transponder would receive when near the identity sensor. The radio signal received by the RFID transponder might then generate a small electrical current that could be used to power a return signal generator. The return signal generator might then transmit a radio signal corresponding to a unique identifier associated with that particular RFID transponder. The identity sensor might then receive this return signal and record the identifier of the RFID transponder. Thus, a user could visit and utilize the sanitizing station without having to swipe a card or otherwise present an ID badge to permit the washing station to record that the user was at the station and that washing or sanitizing fluid was dispensed.

The sensors built into the washing stations 500 and 600, as well as other similar units, could be configured to ensure that fluid will not be dispensed without a user's hands being beneath the faucet and to ensure that a user is not recorded to have visited the station without having positioned his/her hands beneath the faucet to receive the fluid. Having a passive identity verifying and recording device such as the RFID arrangement may be desirable in the sanitizing and access control systems that have been described above and it is anticipated that these passive identity verification approaches may be incorporated into any of the systems described above.

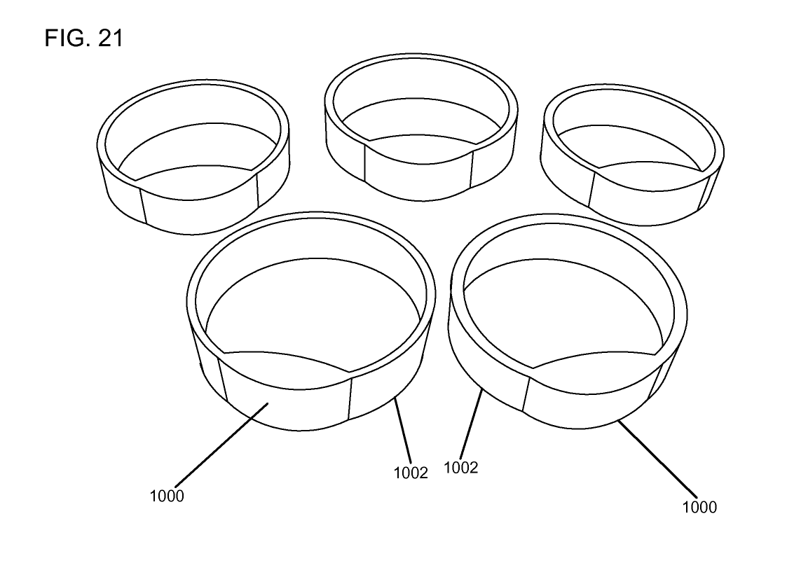

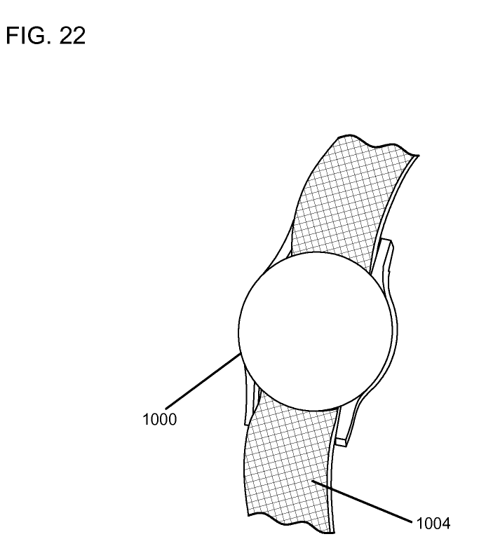

FIGS. 21 and 22 illustrates different embodiments of an RFID transponder incorporated into a wristband or bracelet that may be worn by a user. By placing RFID transponder 1000 adjacent the user's hands, the range of detection for both the fluid flow sensor and the identity sensor can be configured similarly as well. When the user's hands are positioned to receive the fluid from the faucet, the RFID transponder on the user's wrist is position to have its presence detected by the RFID sensor. FIG. 21 illustrates a transponder 1000 and a bracelet 1002 that are integrally formed, while FIG. 22 shows transponder 1000 removably mounted to a bracelet 1004. These are illustrative examples only and are not intended to limit the nature or range of transponders that may be carried or worn by a person for use in conjunction with an RFID sensor in an access control or sanitization station in accordance with the present disclosure.

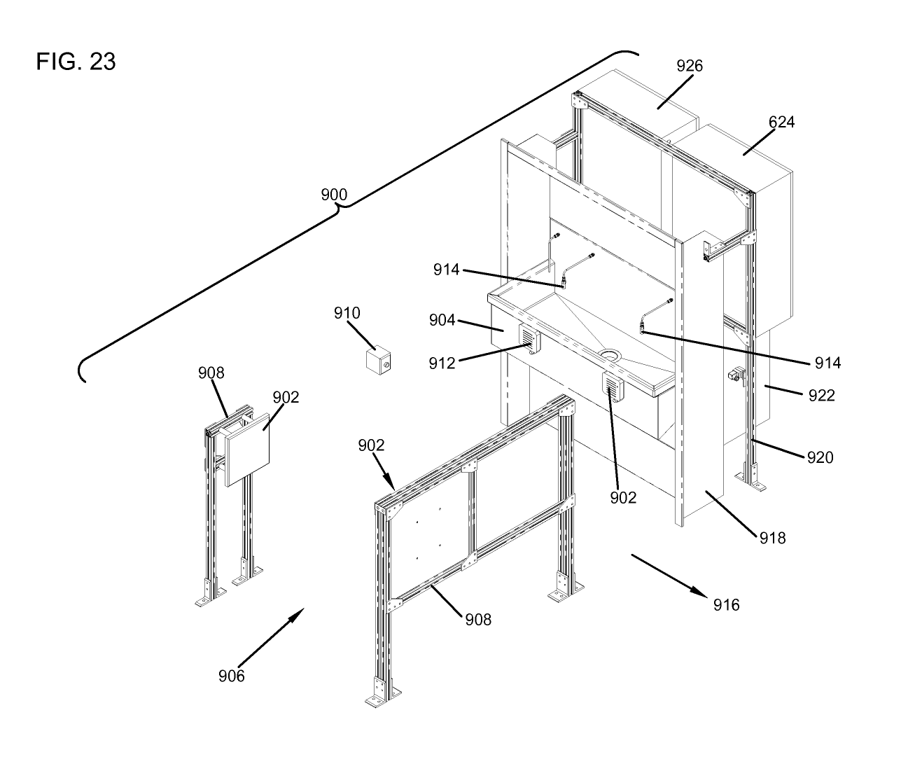

Referring now to FIG. 23, an access control and sanitizing station 900 is shown which includes a pair of proximity badge readers 902 positioned along an approach 906 to the sanitizing sink 904. As shown, proximity badge readers 902 are mounted to free standing supports 908 that cooperate to define approach 906. Alternatively, station 900 could be positioned within a structural location, such as the end of a hallway, which provides walls or barricades defining approach 906 and readers 902 could be mounted directly to the walls or barricades. As configured, an alarm or security sensor 910 may be provided between readers 902 and sink 904 to detect the passage of a person approaching the sink and the point of access to the protected area without having an appropriate card or badge. Unless one or both of the readers 902 have sensed a card or badge, a person passing sensor 910 would set off an alarm.

Alternatively, a door could be positioned between readers 902 and sink 904. The door could include an automatic lock which is only actuated when the presence of a badge is sensed by one or both readers 902, preventing access to the protected area. A second card reader 912 is mounted to a front of sink 904 and corresponds to the location of a spray nozzle 914. Multiple card readers 912 and nozzles 914 associated with the readers may be included as needed or desired in sink 904. Once the possessor of an appropriate badge has approached sink 904, the user will bring their badge into range of one of the readers 912. Once reader 912 senses an appropriate badge, station 900 will initiate the dispensing of a predetermined amount of sanitizing compound through the nozzle 914 associated with the particular reader.

Once the user has approached one of the readers 912 and had sanitizing compound dispensed, then the user is permitted to enter the protected area through entry point 916. If a user with an appropriate badge passes readers 902 but does not approach one of the readers 912 within a specified period of time, an alarm can be set off. A door with an automatic lock may mounted in entry 916 and access through the door prevented until one of the nozzles 914 has dispensed the predefined amount of sanitizing compound.

Sink 904 is shown mounted to and supported by a sink support 918. Support 918 may be connected to or mounted adjacent to a frame 920. Mounted to an opposite side of frame 920, away from the user side of sink 904, are a fluid enclosure 922, an electrical or control enclosure 924 and a pneumatics or valve enclosure 926. These enclosures may contain any necessary bulk containers of potentially flammable sanitizing compounds (enclosure 922), any necessary switches, processors, or other electronic circuitry to operate station 900 (enclosure 924) and any necessary valves for operation of sink 904 and dispensing of the sanitizing compound through nozzles 914. The arrangement and contents of each of these enclosures has been described above.

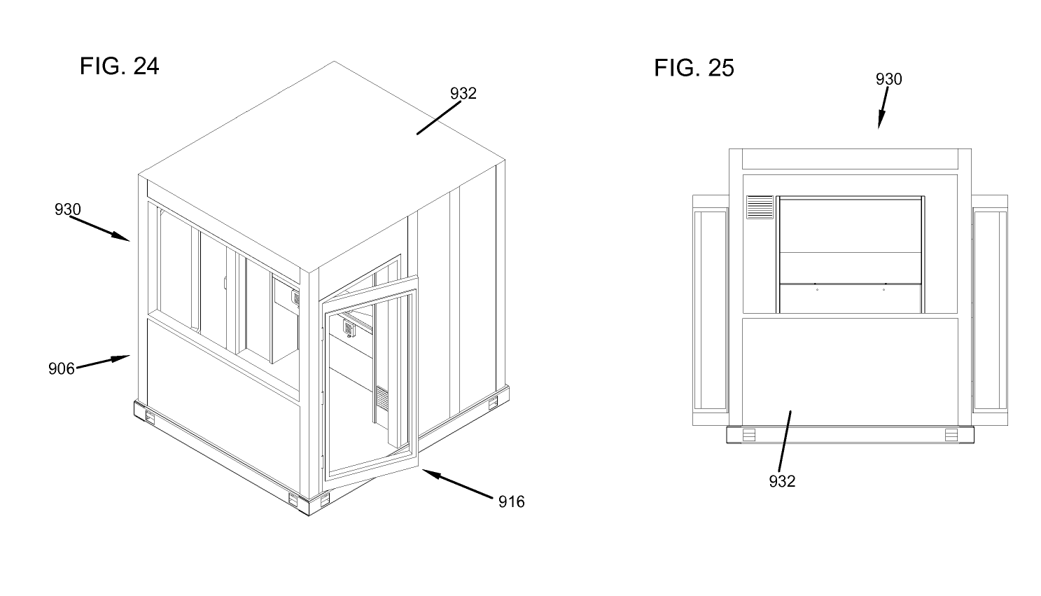

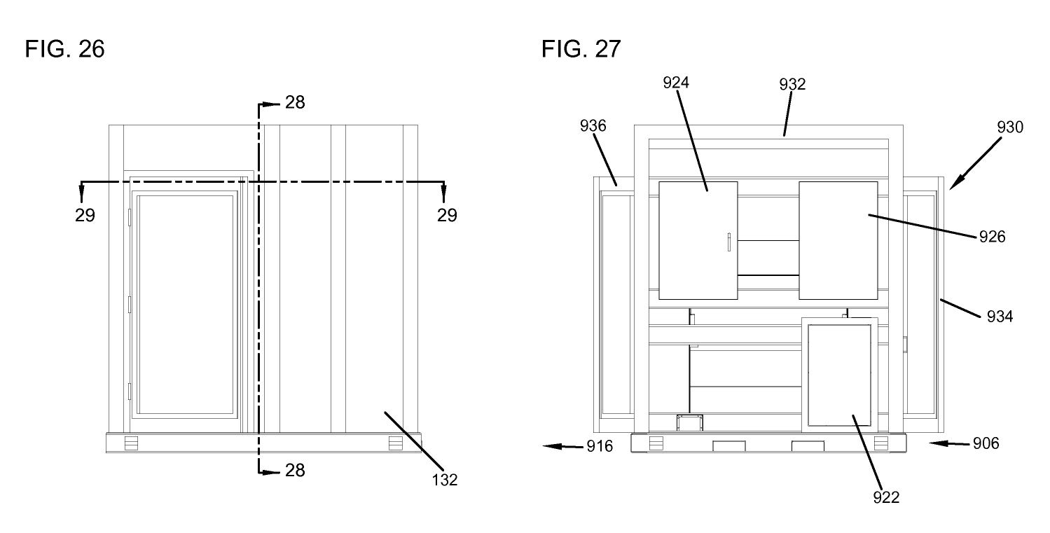

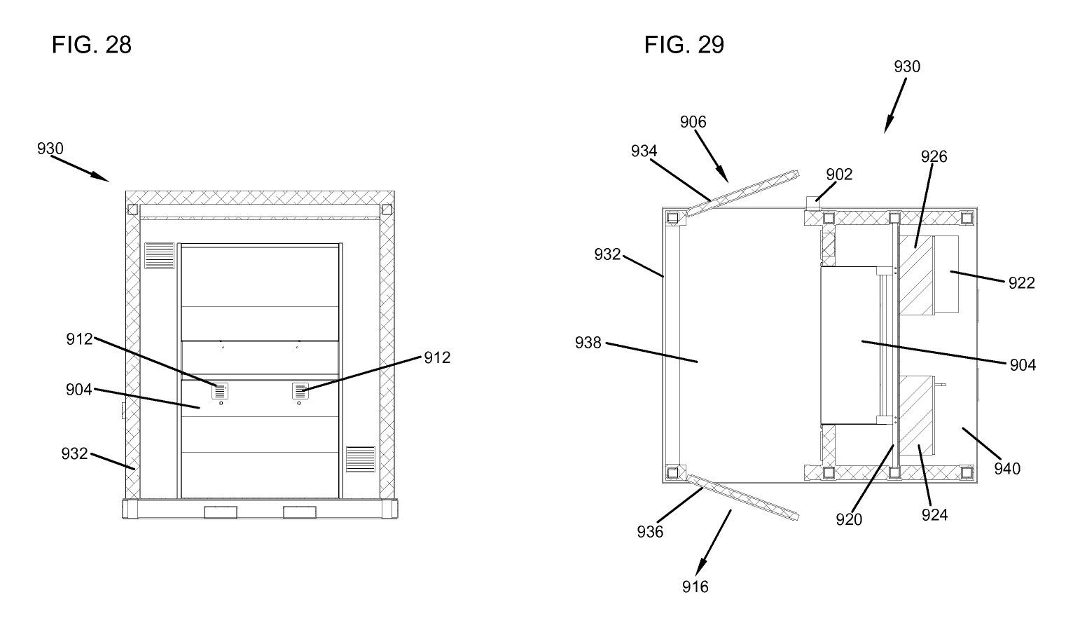

Referring now to FIGS. 24 to 29, a self contained sanitizing and access control station 930 includes many the elements described above with to station 900. In addition to these elements, station 930 includes a fixed enclosure 932 about the elements to provide for controlled access to sink 904 and beyond sink 904 through access point or entry 916. On a first side of enclosure 932 is approach 906 and one an opposite side is entry 916 for accessing the protected area. A first door 934 is provided to selectively close approach 906 until an appropriate badge has been exposed to a reader 902 adjacent approach 906. Once reader 902 has sensed the presence of an authorized badge, door 934 is permitted to open, allowing access to an interior space 938 of enclosure 932 in front of sink 904.

Mounted to a front of sink 904 are one or more card readers 912 to actuate the dispensing of sanitizing compound in sink 904 when an appropriate badge comes into proximity of the reader. Once an appropriate badge has been read by reader 912, sanitizing compound may be dispensed in sink 904 and a second door 936 opposite first door 934 may be unlatched to permit the user to pass through entry 916 into the protected area. Doors 934 and 936 are preferably self-closing and include automatic locks that permit opening for appropriate users and are timed to relatch after a reasonable length of time.

As shown, station 930 also includes support 918 with enclosures 922, 924 and 926 mounted. Preferably, these enclosures are not accessible to a user passing through interior 938. This should help reduce the risk of tampering with the controls or compounds of station 930. Preferably, these enclosures are only accessible through an rear secure compartment 940 to ensure secure and controlled access by authorized personnel. The compartmentalization of the various components into the three distinct enclosures or modules has been driven at least partially by regulatory requirements to separate functions to reduce exposure of the potentially flammable sanitization compound to spark or other ignition sources. As the control and actuation mechanisms of the present disclosure are refined, one or more of the enclosures may be removed from stations constructed according to the present disclosure. Some isolation of the sanitization compound may be desirable or required for regulatory compliance but the other functions housed within the enclosures may be subject to combination permitted by technology advances or changes to the regulatory schemes.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. A hand sanitizing station positioned at a point of entry to a protected area, the station comprising:
a fluid module including a reservoir of sanitizing solution;
a control module including electronic controls and data recording devices;
a sanitizing unit in fluid communication with the plumbing module;
a first reader positioned adjacent the sanitizing unit and electronically connected with the control module;
a valve module including plumbing and at least one valve for controlling movement of sanitizing solution from the plumbing module to the sanitizing unit, the at least one valve electronically connected to the control module;
the control module configured to actuate the at least one valve within the plumbing module to deliver of sanitizing solution from the reservoir to the sanitizing unit when a person activates the sanitizing unit by presenting an electronically readable identification device to the first reader, the control module recording information from the identification device presented and the actuation of the at least one valve, and associating an activation of the sanitizing unit with the information.

2. The hand sanitizing station of claim 1, further comprising a second reader positioned adjacent an approach to the sanitizing unit, the second reader configured to detect the electronically readable identification device of the user approaching the sanitizing unit, the second reader electronically connected to the control module, the control module recording information from the identification device passing the second reader.

3. The hand sanitizing station of claim 2, further comprising a door including a lock latched to prevent access to the sanitizing unit, the lock configured to unlatch when the second reader detects the passage of an identification device to permit the person carrying the identification device to approach the sanitizing device.

4. The hand sanitizing station of claim 1, further comprising a door including a lock, latched to prevent access to the protected area, the lock configured to unlatch after the first reader detects the presentation of the identification device and the sanitization unit has been activated to permit the person carrying the identification device to access the protected area.

5. The hand sanitizing station of claim 2, further comprising the control module being connected to a telecommunications network, the control module sending an alarm to another device on the network if a person with an identification device passes the second reader and does not present the identification device to the first reader to activate the sanitizing unit before entering the protected area.

6. The hand sanitizing station of claim 1, further comprising the control module being connected to one or more devices mounted adjacent the sanitizing unit to sense and collect biometric information regarding any person activating the sanitizing unit.

7. The hand sanitizing of claim 6, further comprising the control module being connected to a telecommunications network, the control module configured to send an alarm to another device on the network if the biometric information sensed by the sensor is outside of certain predefined parameters.

8. A sanitizing system comprising:
a sanitizing unit;
a passage permitting access to the sanitizing unit including a badge reader configured to detect the passage of an identification badge through the approach toward the sanitizing unit;
a badge reader adjacent the sanitizing unit configured to detect an identification badge and activate the sanitizing unit when an identification badge is presented at the sanitizing unit;
a point of entry permitting access to a protected area;
a control module connected to the badge reader of the approach and configured to record any identification badges approaching the sanitizing unit, the control unit also connected to the badge reader adjacent the sanitizing unit and configured to record any identification badges presented to the badge reader to activate the sanitizing unit.

9. An access control system comprising:
a sanitizing unit;
a passage permitting access to the sanitizing unit including a badge reader configured to detect the passage of an identification badge through the passage toward the sanitizing unit;
a badge reader adjacent the sanitizing unit configured to detect an identification badge and activate the sanitizing unit when an identification badge is presented at the sanitizing unit;
a point of entry permitting access to a protected area;
a control module connected to the badge reader of the approach and configured to record any identification badges detected within the passage, the control unit also connected to the badge reader adjacent the sanitizing unit and configured to record any identification badges presented to the badge reader to activate the sanitizing unit
the point of entry blocked by a door with a lock connected to the control module, the control module unlatching the lock to permit the door to open when an identification badge is detected within the passage and presented to activate the sanitizing unit, so that a person carrying the identification badge may enter the protected area.
